(19) United States
(12) Patent Application Publication
(10) Pub. No.: US 2026/0099313 A1
(43) Pub. Date: Apr. 9, 2026

(54) SYSTEMS AND METHODS FOR SECURELY UTILIZING MACHINE LEARNING MODELS TO CONFIGURE NETWORK CLOUD SOFTWARE CODE CHANGES

(71) Applicant: Verizon Patent and Licensing Inc., Basking Ridge, NJ (US)

(72) Inventors: Deepak MAJJIGA, Irving, TX (US); Neeraj BHATT, Vienna, VA (US)

(73) Assignee: Verizon Patent and Licensing Inc., Basking Ridge, NJ (US)

(21) Appl. No.: 18/906,614

(22) Filed: Oct. 4, 2024

(51) Int. Cl. G06F 8/65

(52) U.S. Cl. CPC G06F 8/65

(57) ABSTRACT

A device may securely receive a variety of artifacts, such as CSARs, container images, and data source data for cloud software code, and may generate individual repositories or data lakes based on the CSARs, the container images, and the data source data. The device may generate a deployment method of procedure as a prompt list for a change to the cloud software code. The device may process the prompt list, with a machine learning model, to generate a generic artifact template, and may substitute operator specific variables in the generic artifact template to generate an operator specific artifact template. The device may substitute site specific variables in the operator specific artifact template to generate a site specific artifact template, and may provide the site specific artifact template to an orchestrator system for implementation of the change to the cloud software code.

### BACKGROUND

In the telecommunications industry, the deployment and management of software for cloud computing environments (e.g., virtual network functions (VNFs) and container network functions (CNFs)) face significant challenges in terms of efficiency and security.

### BRIEF DESCRIPTION OF THE DRAWINGS

FIGS. 1A-1J are diagrams of an example associated with securely utilizing machine learning models to generate cloud software code changes.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for securely utilizing machine learning models to generate cloud software code changes.

### DETAILED DESCRIPTION OF EXAMPLE EMBODIMENTS

The following detailed description of example implementations refers to the accompanying drawings. The same reference numbers in different drawings may identify the same or similar elements.

The smallest unit of software, based on cloud service archives (CSARs), is often bulky and contains an array of components, such as helm charts, container images, configuration files, and methods of procedure (MOPs). Consequently, even minor updates or changes to cloud software code necessitate redeployment of the entire CSARs, resulting in time-consuming and resource-intensive processes for installation and for orchestration and functional testing. The traditional method for providing cloud software changes fails to keep up with the latest cloud software code releases from suppliers, and fails to provide a streamlined or incremental update approach. Moreover, the deployment scripts and workflows used in application operations are often hardcoded with operator specific and site specific parameters. These hardcoded parameters pose substantial difficulties when accommodating changes (e.g., major changes such as topology changes or minor changes such as Internet protocol (IP) addresses, timers, feature enablement in locations, and/or the like), where even minor variations can require significant coding efforts and recertification. This is further compounded by the existing multiple and disparate staging environments (e.g., development, maintenance, lab, and production environments) used by both suppliers and operators.

Thus, current techniques for handling cloud software code changes consume computing resources (e.g., processing resources, memory resources, communication resources, and/or the like), networking resources, and/or other resources associated with requiring significant coding efforts for minor updates or changes to cloud software code, failing to keep up with the latest cloud software code releases from suppliers (e.g., due to misinterpretation of requirements, lack of coordination, and/or the like), failing to provide a streamlined or incremental update approach, failing to efficiently handle hardcoded parameters associated with changes to cloud software code, and/or the like, which eventually causes delays in timelines.

Some implementations described herein relate to a development system that securely utilizes machine learning models to generate cloud software code changes based on application feature changes, bug fixes, application enhancements, and/or the like. For example, the development system may securely receive CSARs, container images, and data source data for cloud software code, and may generate a repository based on the CSARs, a container image repository based on the container images, and a data lake based on the data source data. The development system may generate a deployment method of procedure as a prompt list for a change to the cloud software code and based on information stored in the repository, the container image repository, and the data lake. The development system may process the prompt list, with a machine learning model, to generate a generic artifact template, and may substitute operator specific variables in the generic artifact template to generate an operator specific artifact template. The development system may substitute site specific variables in the operator specific artifact template to generate a site specific artifact template, and may provide the site specific artifact template to an orchestrator system for implementation of the change to the cloud software code or may execute the site specific artifact template to deploy an application.

In some implementations, the development system may package an application in a CSAR format that includes Helm charts, images, and files. The CSAR may also include ansible scripts, Python language, and a shell. The development system may provide automation that has a one-to-one mapping with the application, such as a Secure CoPy (SCP) automation that is customized to an SCP application. The development system may automatically generate automation related to the application. In some examples, the development system may generate all of the automation code for a fresh install, may generate a delta automation based on upgrade MOPs, and/or the like. The development system may pass the automation in layers to insert operator specific and site specific values.

In this way, the development system securely utilizes machine learning models to generate cloud software code changes or generate new code for new applications and/or network functions from a MOP. For example, the development system may receive network function CSARs, container images, MOPs, and data source data for cloud software code within a secure environment and may construct respective repositories and data lakes. The development system may utilize the respective repositories and data lakes to generate a prompt list for generating and updating cloud software code, and may process the prompt list with a machine learning model to produce a generic artifact template. The development system may personalize the generic artifact template with operator specific variables and site specific variables to establish a deployable, site specific artifact template. The development system may provide this template to an orchestrator system for implementing the software changes. Thus, the development system may conserve computing resources, networking resources, human resources, and/or other resources that would have otherwise been consumed by requiring significant coding efforts for minor updates or changes to cloud software code, failing to keep up with the latest cloud software code releases from suppliers, failing to provide a streamlined or incremental update approach, failing to efficiently handle hardcoded parameters associated with changes to cloud software code, and/or the like.

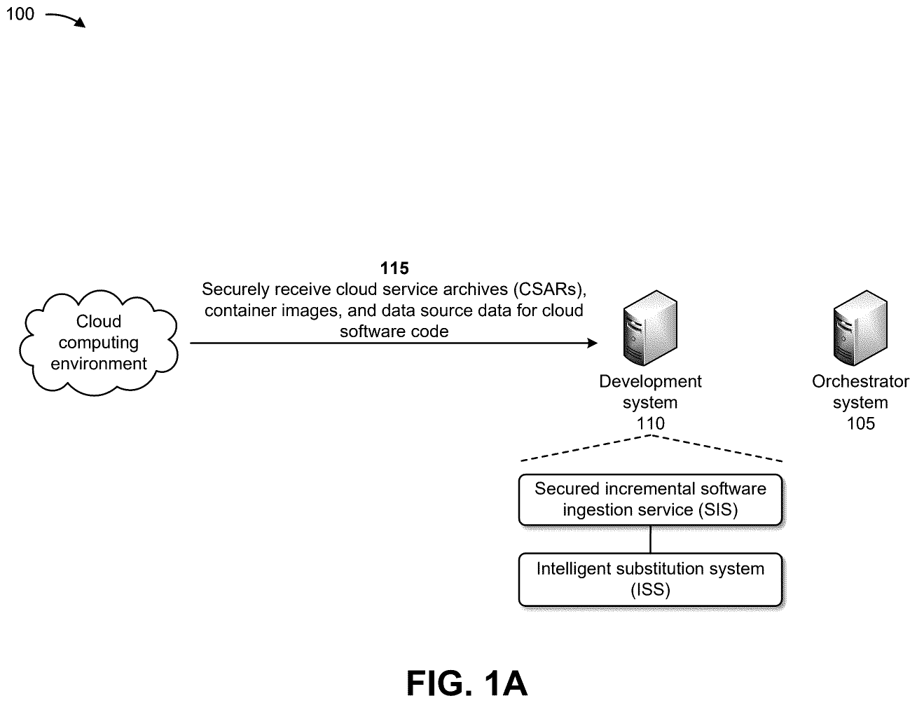

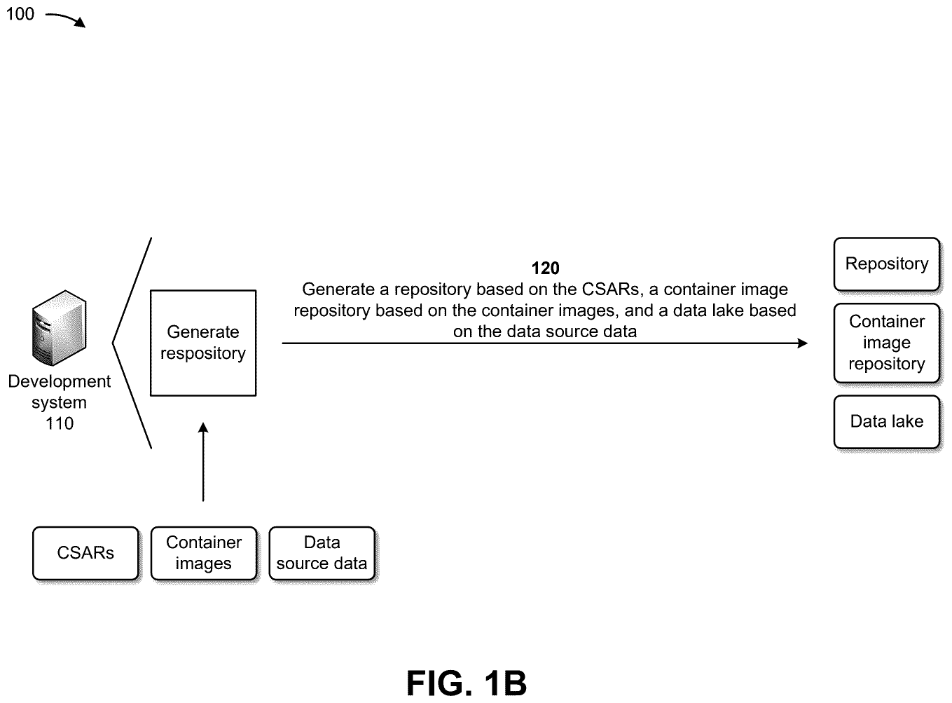

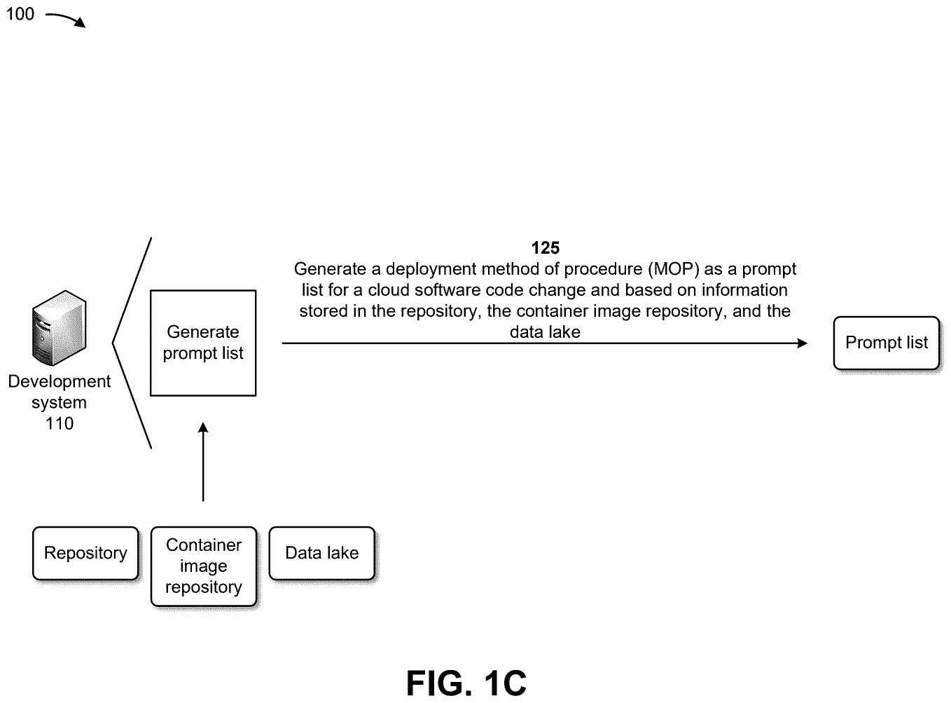

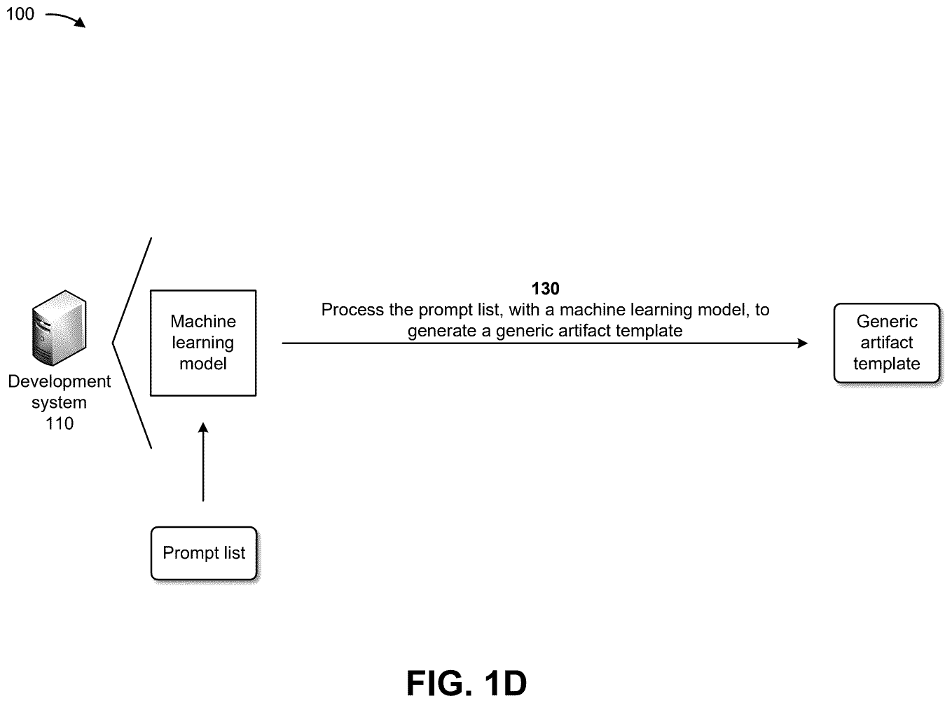

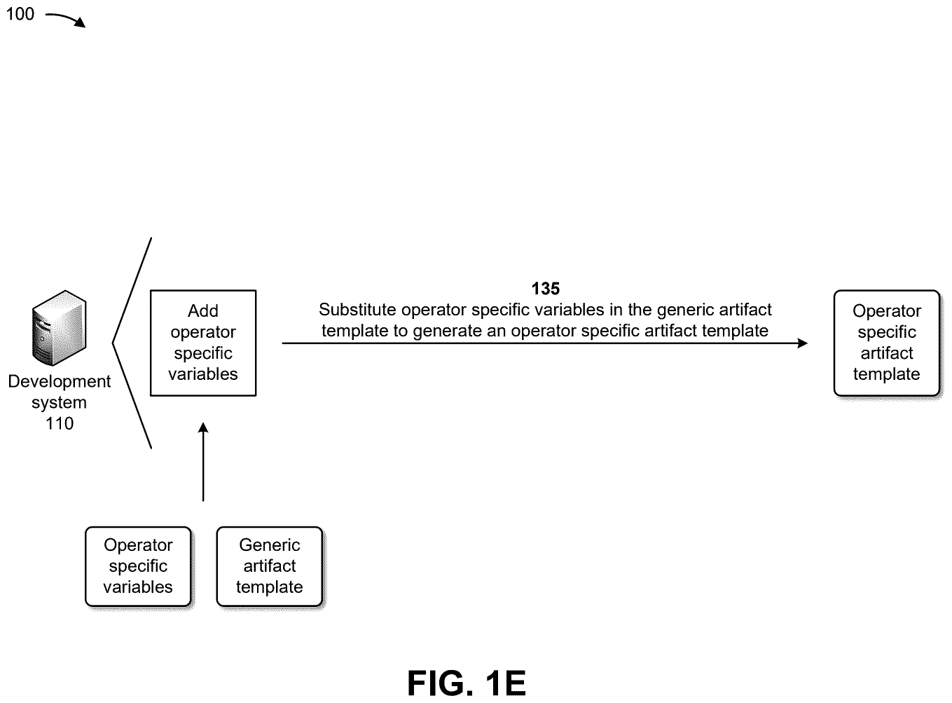

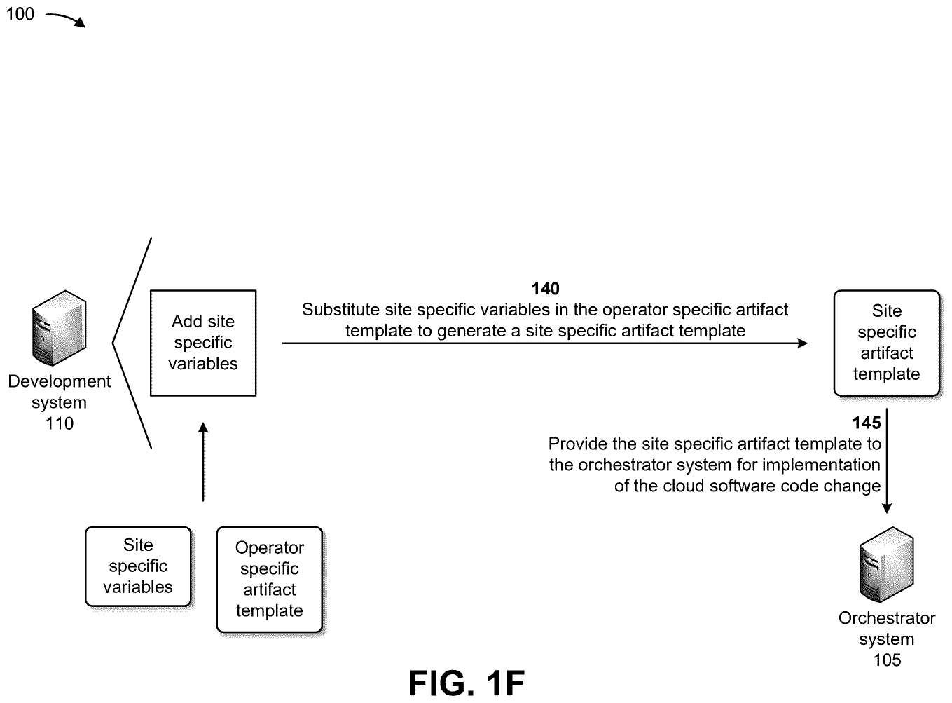

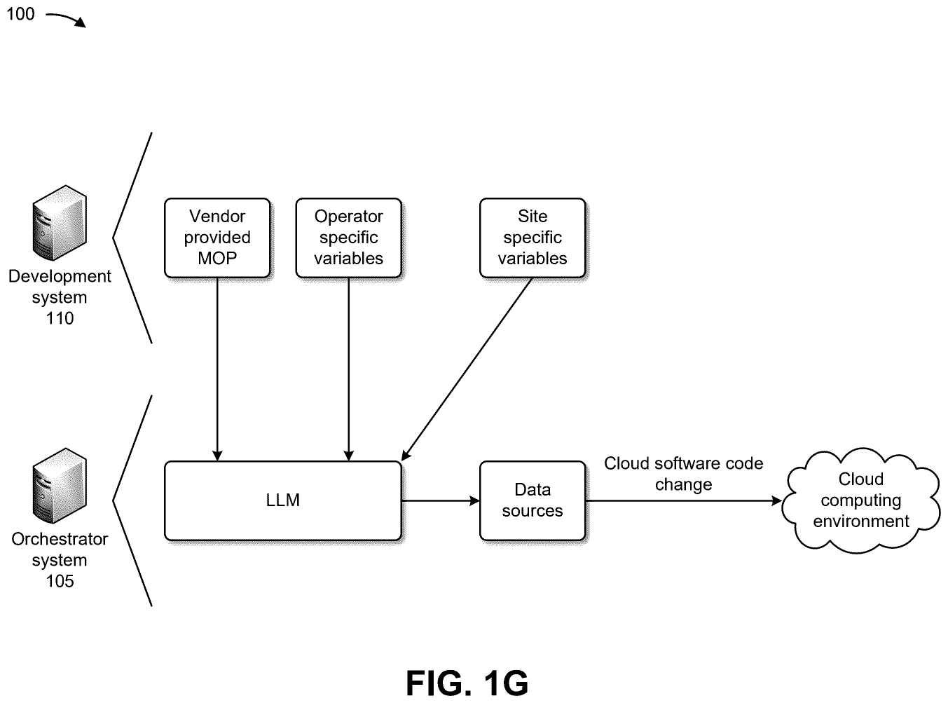

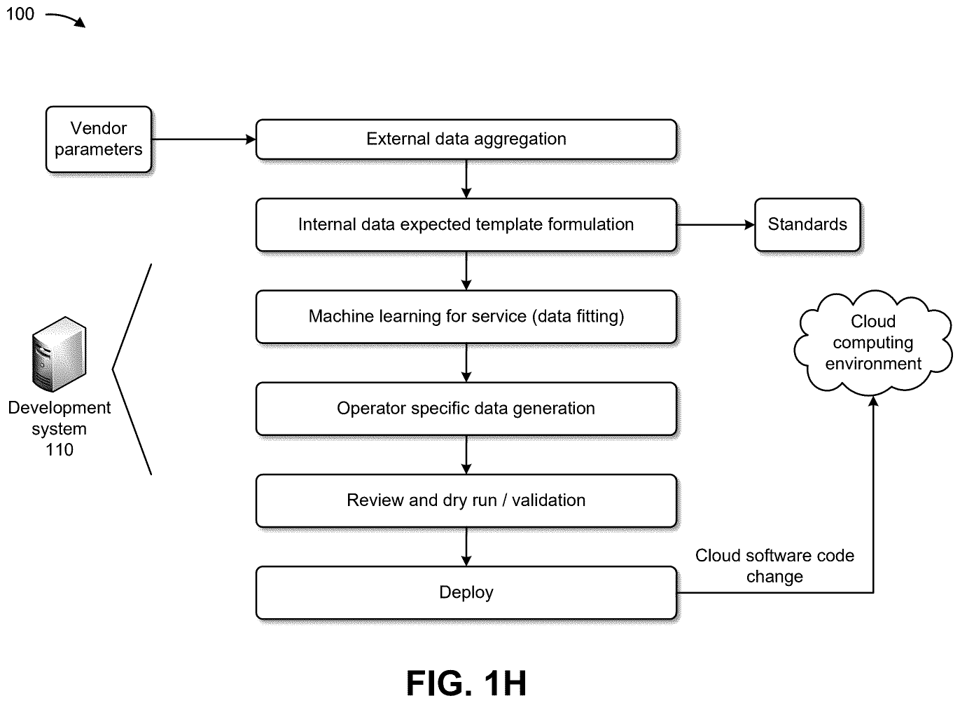

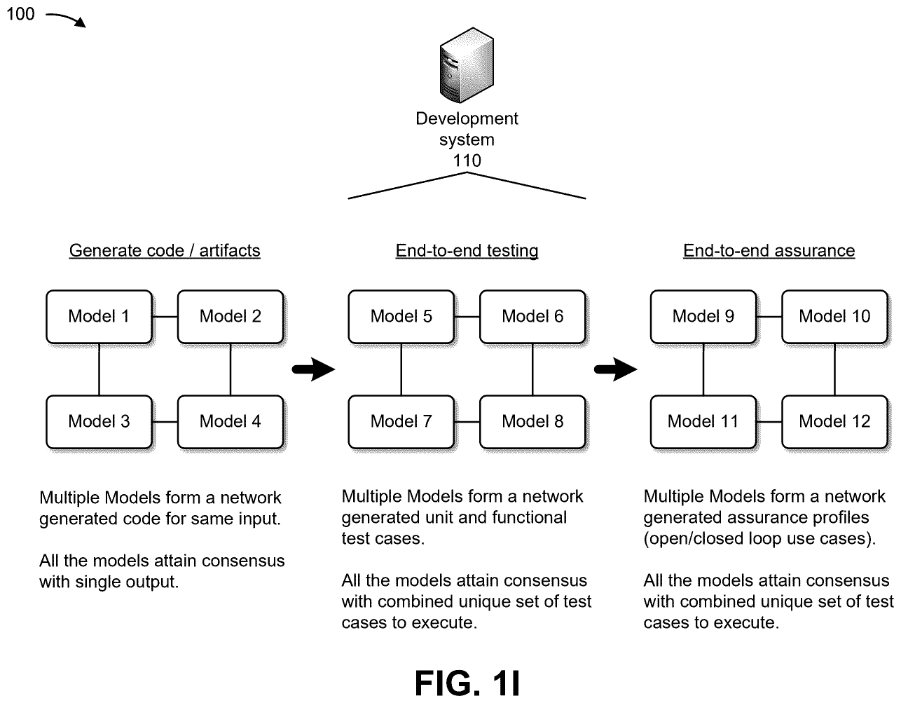

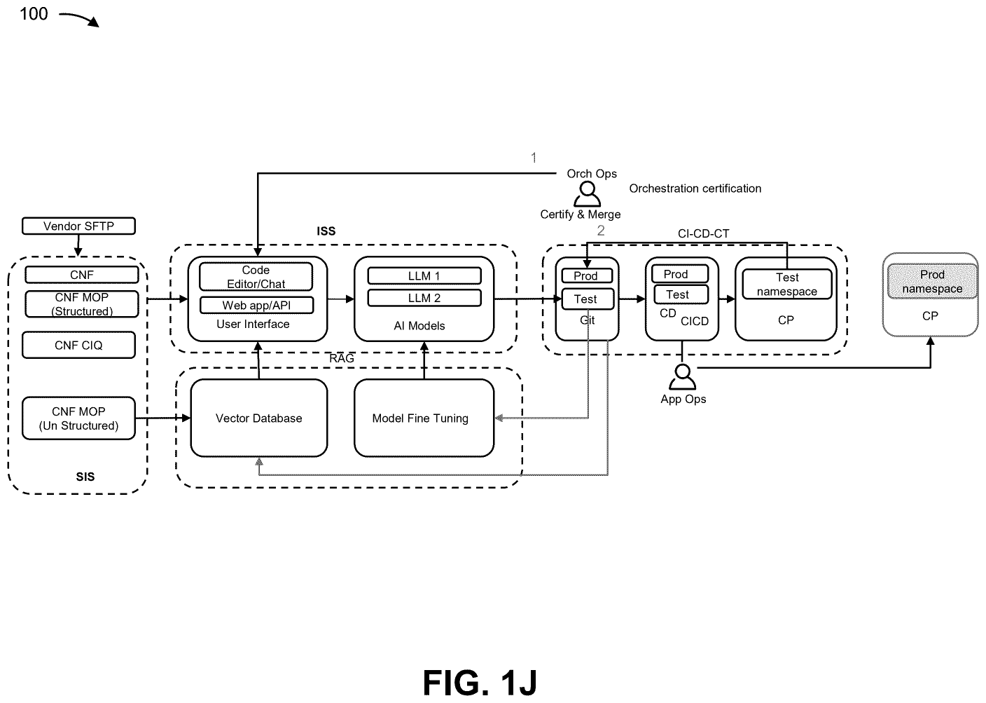

FIGS. 1A-1J are diagrams of an example 100 associated with securely utilizing machine learning models to generate cloud software code changes. As shown in FIGS. 1A-1J, example 100 includes an orchestrator system 105 associated with a cloud computing environment and a development system 110. Further details of the orchestrator system 105, the cloud computing environment, and the development system 110 are provided elsewhere herein.

As shown in FIG. 1A, the development system 110 may include a secured incremental software ingestion service (SIS) component and an intelligent substitution service (ISS) component. The SIS component may receive CSARs, container images, MOPs, data source data, helm charts, configuration files, and/or the like for cloud software, and may perform a secure pre-auditing service on the received information (e.g., by scanning artifacts, images, data flows, and/or the like for vulnerabilities and/or threats). The ISS may include multiple implementations that substitute operator specific and site specific details in machine learning model generated software code. Further details of the SIS and the ISS are provided elsewhere herein.

As further shown in FIG. 1A, and by reference number 115, the development system 110 may securely receive network function CSARs, container images, MOPs, and data source data for cloud software code. For example, the SIS component of the development system 110 may securely receive the network function CSARs, the container images, and the data source data for the cloud software code from the cloud computing environment associated with suppliers or other sources. In some implementations, the development system 110 may perform data analysis of the CSARs, the container images, and the data source data to identify specific changes needed in the cloud software code. This may involve analyzing the structure, dependencies, and content of the received information to determine the software code modifications.

The SIS component enables the development system 110 to obtain application CSARs, helm charts, and images individually and to store the information in respective repositories. With the SIS component, a smallest atomic unit of delivery can be as simple as flat file or a CSAR and any format. Without the SIS component, a smallest atomic unit of delivery is a CSAR.

Additionally, or alternatively, the development system 110 may employ continuous security auditing mechanisms to automatically scan and validate the received information individually (e.g., the CSARs, the container images, and the data source data) for security vulnerabilities and integrity issues as soon as the information is received by the development system 110. For example, the SIS component of the development system 110 may continuously monitor and scan all incoming data individually to identify any potential threats or integrity problems before the incoming data is processed further. In this way, the development system 110 may provide modularity, individuality, flexibility, and security which leads to a faster and leaner way of information transmission between suppliers and operators.

As shown in FIG. 1B, and by reference number 120, the development system 110 may generate a repository based on the CSARs, a container image repository based on the container images, and a data lake based on the data source data. For example, the development system 110 may disaggregate the received CSARs into a structured repository, may catalog the container images into a dedicated container image repository, and may correlate the data source data into a cohesive data lake. The development system 110 may also support non-CSAR data and still catalog and correlate other data. This structured approach may enable efficient data management and retrieval, and may facilitate rapid processing of necessary changes to the cloud software code. The repository may serve as a centralized storage location for various elements, such as helm charts, configuration files, procedural documents, and/or the like. The container image repository may maintain container image versioning and integrity, and the data lake may support complex data analyses derived from the data source data.

This approach may enable the development system 110 to maintain organized records of cloud service archives and container images, which can be efficiently referenced and utilized during changes to the cloud software code. Additionally, or alternatively, the development system 110 may consolidate the CSARs and the container images into a consolidated repository. The consolidated repository may enable streamlined access to both the CSARs and the container images, enhancing overall system operability.

As shown in FIG. 1C, and by reference number 125, the development system 110 may generate a deployment MOP as a prompt list for a cloud software code change and based on manual MOPs, automated MOPs, confluence pages, and information stored in the repository, the container image repository, and the data lake. For example, the development system 110 may analyze the manual MOPs, the automated MOPs, the confluence pages, the disaggregated CSARs in the repository, the cataloged container images in the container image repository, and the correlated data in the data lake to identify specific steps required for deploying the cloud software code change. The identified steps may form a structured prompt list (e.g., a deployment MOP) that includes various elements necessary for the cloud software code change, such as executable commands, configuration changes, integration steps, and/or the like required for the cloud software code. The resulting deployment MOP may significantly streamline the process by ensuring that all necessary steps are accurately and efficiently outlined, facilitating a smooth transition to implementing cloud software code changes.

In some implementations, the development system 110 may compile the deployment MOP as a sequence of instructions for altering the cloud software code, based on data stored in the repository, the container image repository, and the data lake. For example, the deployment MOP may include detailed instructions on how to update configurations or paths for the cloud software code. The prompt list may include various actions such as verification steps and execution orders to ensure a seamless deployment of the cloud software code change. In some implementations, MOPs may be provided by suppliers to handle an application, may be provided by tool-specific items, such as VNFMP, NFVD, ATLAS, may be in confluence pages, and/or the like, and the development system 110 may generate the prompt list based on such information.

In some implementations, the prompt list may specify exact scripts and parameters needed for deployment of the cloud software code change, and may specify tasks to be performed for the cloud software code change, such as end-to-end deployment processes including pre-deployment checks and post-deployment validation. The prompt list may integrate different dependencies and runtime environments required for the cloud software code change. The prompt list may include conditional actions that need to be monitored during the deployment process, and may include guidance that provides roll-back scenarios and recovery steps should any issue be encountered during deployment. The prompt list may include a sequence of actions required for alteration of the cloud software code. The sequence of actions may include detailed annotations for each step to facilitate accurate and efficient execution during the cloud software code change process.

As shown in FIG. 1D, and by reference number 130, the development system 110 may process the prompt list, with a machine learning model, to generate a generic artifact template. For example, the machine learning model may analyze the structured prompt list to extract relevant instructions, parameters, and other necessary elements to form the generic artifact template. The generic artifact template may serve as a baseline format or framework for the cloud software code change, incorporating necessary commands and configurations in a generic and reusable manner. The machine learning model may identify patterns, dependencies, and sequences within the prompt list, ensuring that the generic artifact template aligns with the intended changes to the cloud software code. In some implementations, the prompt list may be structured and easily understood by the machine learning model. Alternatively, some suppliers provide unstructured MOPs with various references to links, images, and other MOPs, creating a complex MOP situation.

In some implementations, the development system 110 may utilize a neural network model to assess the prompt list and craft the generic artifact template. The neural network model may scrutinize the prompt list to derive directives, parameters, and elements to construct the generic artifact template. The neural network model may act as a basic schema for implementing the cloud software code change, embedding essential commands and configurations in a generalizable format. The neural network model may detect regularities, relationships, and procedural steps within the prompt list, ensuring that the cloud software code satisfies the cloud software code change.

In some implementations, the ISS of the development system 110 may provide a layered service for generating the cloud software code change. A first layer of the layered service may process the prompt list, with the machine learning model, to generate the generic artifact template. A second layer of the layered service may substitute operator specific variables in the generic artifact template to generate an operator specific artifact template, as described below in connection with FIG. 1E. A third layer of the layered service may substitute site specific variables in the operator specific artifact template to generate a site specific artifact template, as described below in connection with FIG. 1F.

As shown in FIG. 1E, and by reference number 135, the development system 110 may substitute operator specific variables in the generic artifact template to generate an operator specific artifact template. For example, the development system 110 may analyze the generic artifact template to identify placeholders or variables that need to be customized with operator specific details. The operator specific variables may include paths, versions, environments, endpoints, and/or the like of the orchestrator system 105. The development system 110 may retrieve the operator specific variables from a database or a configuration file containing these specific details. By substituting the generic placeholders with the corresponding operator specific variables, the development system 110 may ensure that a resulting artifact template is tailored to the particular requirements and infrastructure of the operator. The development system 110 may inject correct values for each identified variable, ensuring that the operator specific artifact template conforms to the operational needs and deployment configurations unique to the operator. This may enable the generic artifact template, initially created by the machine learning model, to be effectively utilized in an operator's environment, thereby streamlining and enabling accurate and efficient deployment of the cloud software code change.

In some implementations, the development system 110 may verify that all necessary operator specific variables are identified and correctly mapped before initiating the substitution process. This verification may prevent errors during generation of the operator specific artifact template, ensuring all substitutions are complete and accurate. Additionally, or alternatively, the development system 110 may retrieve the operator specific variables from a remote database through a secure application programming interface (API). This allows for real-time access to the latest configuration data, enhancing the flexibility and responsiveness of the development system 110.

In some implementations, the development system 110 may perform validation checks (e.g., authentication tests or access tests such as ping, curl, telnet, and/or the like) to ensure that the substituted operator specific variables are correctly applied and meet predefined criteria. The validation checks may include comparing the newly generated operator specific artifact template against a set of rules or standards to confirm its correctness. Additionally, or alternatively, the development system 110 may provide a preview of the operator specific artifact template before finalizing and committing the changes. Offering a preview may enable operators to review and confirm the changes before they are applied, reducing a risk of deployment issues. Additionally, or alternatively, the development system 110 may utilize a machine learning model to recommend or auto-fill commonly used operator specific variables based on historical deployment data. This may significantly increase the substitution process and improve accuracy by leveraging past knowledge.

In some implementations, the development system 110 may facilitate collaboration by allowing operators to manually review and adjust the substituted variables in the operator specific artifact template. Enabling manual intervention allows for fine-tuning and adjustments. Additionally, or alternatively, the development system 110 may log the substitution process, including the original and substituted values, for auditing and debugging purposes. Maintaining detailed logs may ensure transparency and traceability, which may be essential for diagnosing issues and continuous improvement. Additionally, or alternatively, the development system 110 may manage different versions of operator specific variables to ensure compatibility with various orchestrator systems 105. Version handling may support backward compatibility and smooth transitions across different system updates.

In some implementations, the development system 110 may utilize schema validation to ensure that the operator specific artifact template adheres to required format and standards. Schema validation may detect and flag any inconsistencies or errors in the template structure before deployment. Additionally, or alternatively, the development system 110 may update the predefined database or configuration file with new operator specific variables after each successful deployment. Updating the database or configuration file may ensure that the most current operator specific variables are available for future template generation. Additionally, or alternatively, the development system 110 may generate a report summarizing the substitution process and any issues encountered. A summary report may be utilized for post-deployment reviews and continuous process improvement. In some implementations, the development system 110 may utilize schema validation on operator specific values and site specific values.

In some implementations, the development system 110 may execute automated tests on the operator specific artifact template to ensure that the template performs as expected in different scenarios. Automated testing may identify potential issues before the operator specific artifact template is deployed in a live environment. Additionally, or alternatively, the development system 110 may revert to a previous version of the operator specific artifact template if any errors are detected during the substitution process. The ability to roll back changes may ensure stability and reliability. In some implementations, the development system 110 may execute automated tests on operator specific values and site specific values. For example, the development system 110 may test a site with test data.

As shown in FIG. 1F, and by reference number 140, the development system 110 may substitute site specific variables in the operator specific artifact template to generate a site specific artifact template. For example, the development system 110 may analyze the operator specific artifact template to identify placeholders or variables that need to be customized with site specific details. The site specific variables may include network addresses, namespaces, deployment locations, orchestrator hierarchy (e.g., organization, domain, supplier, application, etc.) and/or other details pertinent to the deployment at a specific site. The development system 110 may retrieve the site specific variables from a database or a configuration file that maintains site specific details. This may ensure that the final artifact template is fully customized to meet the unique requirements of a deployment site, and may facilitate precise and efficient implementation of the cloud software code change. The development system 110 may ensure that each placeholder within the operator specific artifact template is correctly utilized with the appropriate site specific variables to deploy an application, aligning the operator specific artifact template with site specific configurations and deployment protocols.

In some implementations, the development system 110 may replace operator specific variables with site specific details within the operator specific artifact template (e.g., only values will be replaced and not a complete key value pair). For example, the operator specific variables may be systematically located and replaced by corresponding site specific data to achieve the required customization. Additionally, or alternatively, substituting site specific variables may include extracting site specific data, such as Internet protocol (IP) addresses, configuration parameters, and other regional settings from a centralized repository to personalize the operator specific artifact template. Additionally, or alternatively, the development system 110 may map custom site variables stored in a configuration management database to the appropriate placeholders in the operator specific artifact template. This mapping process may automate the customization, may reduce errors, and may ensure that each site specific variable is accurately integrated into the template.

As further shown in FIG. 1F, and by reference number 145, the development system 110 may provide the site specific artifact template to the orchestrator system 105 for implementation of the cloud software code change. For example, the development system 110 may provide the site specific artifact template to the orchestrator system 105 via a secure communication protocol to ensure the integrity and confidentiality of the template during transfer. The orchestrator system 105 may utilize the site specific artifact template to deploy the updated cloud software code in the specified site environment (e.g., the cloud computing environment). The deployment process may include executing the site specific configurations and commands outlined in the site specific artifact template to achieve desired changes in the cloud software code. The development system 110 may conduct post-deployment validation checks to ensure successful application of changes and proper functionality of the cloud software code in the live environment, thus ensuring seamless and efficient deployment of updates with minimized risk of errors or conflicts.

In some implementations, the development system 110 may utilize an encrypted data channel to provide the site specific artifact template to the orchestrator system 105. This may ensure that the template remains secure and unaltered during transmission. Additionally, or alternatively, the development system 110 may push the site specific artifact template to the orchestrator system 105 to ensure that delivery follows authentication and verification processes to prevent unauthorized access. Additionally, or alternatively, the development system 110 may hand off the site specific artifact template to the orchestrator system 105, which will then use the template to execute the deployment commands necessary for implementing the changes to the cloud software code. Additionally, or alternatively, the development system 110 may integrate the site specific artifact template into a workflow of the orchestrator system 105 that handles lifecycle management, including deployment, scaling, and rollback operations.

FIG. 1G depicts a first example configuration of the ISS component of the development system 110 in relation to the orchestrator system 105. As shown, the development system 110 may receive a vendor provided MOP containing the technical steps and configurations necessary for implementing changes in the cloud software code. The MOP may provide a comprehensive guideline for deploying updates and executing tasks within the cloud software code. The development system 110 may also receive operator specific variables and site specific variables. The orchestrator system 105 may include a large language model (LLM) configured to interact with the vendor provided MOP, the operator specific variables, and various data sources to execute cloud software code changes. By analyzing the vendor provided MOP, the LLM may parse necessary instructions and frameworks required for customization.

The operator specific variables may include data unique to operator infrastructure, such as paths, versions, environments, and endpoints specific to the orchestrator system 105. These variables may ensure that the generated artifacts align with the operator's specific operational requirements and configurations. The site specific variables may include network addresses, namespaces, deployment locations, and other details pertinent to the deployment at a specific site or environment. These variables may enable the development system 110 to further personalize the output to match the unique needs and settings of each deployment site, thus ensuring a seamless and efficient update process.

The LLM may process the vendor provided MOP, the operator specific variables, and the site specific variables. By analyzing this comprehensive dataset, the LLM may generate tailored artifact templates required for updating and managing the cloud software code. The output from the LLM may be provided to the data sources to enact the cloud software code change within the cloud computing environment. This may facilitate the transfer of custom-configured artifacts to the orchestrator system 105, which then executes the deployment steps and updates the cloud software code within a specified environment.

FIG. 1H depicts a second example configuration of the ISS component of the development system 110. For example, the development system 110 may receive vendor parameters and may perform external data aggregation to compile necessary information. The external data aggregation may collect various deployment parameters from different vendors. In some implementations, the external data aggregation may include obtaining multiple deployment parameters from different vendors and aggregating them into a unified data repository. Additionally, or alternatively, the external data aggregation may include obtaining configuration files, scripts, and operational standards from diverse vendor environments. These collected resources can be used to standardize deployment processes across various environments.

The development system 110 may formulate an internal data expected template by creating an expected template outlining a structural framework based on standards. The template may streamline future substitution processes required for generating operator specific and site specific artifact templates. In some implementations, the template formulation may include formulating a base template incorporating the disaggregated data to serve as a structural benchmark for further processes. The base template may set up a standardized framework that can be reused for different deployments. Additionally, or alternatively, the template formulation may include creating a generalized template that standardizes the vendor parameters for seamless data integration. Once the generalized template is created, the vendor data may be fitted into the generalized template.

Next, the development system 110 may utilize a machine learning model (e.g., data fitting) to process the disaggregated data and the template. The machine learning model may analyze and map the disaggregated data to align with the predefined template. Data fitting may ensure a seamless integration of the vendor parameters into service models. Techniques such as clustering, regression, or classification may be utilized to accurately match the data to the templates.

The development system 110 may generate operator specific data from the fitted data. This may involve substituting the internal data template's placeholders with variables pertinent to specific operators, such as paths, versions, environments, and endpoints of the orchestrator system 105. This transforms the generic template into an operator specific artifact template. In some implementations, the operator specific data generation may include mapping generic data templates to specific operator configurations, entailing paths, environment variables, endpoint information, and custom scripts.

The development system 110 may then perform a review and dry run/validation process. During this process, the operator specific artifact template may undergo extensive validation and dry runs to ensure correctness and operational readiness. The process may include testing for compatibility with the specified operator's infrastructure and validating the accuracy of the substituted variables. In some implementations, pre-deployment validation may include simulated deployments in a controlled environment to test compatibility and functionality.

Upon successful validation, the development system 110 may deploy the validated artifact template to the cloud computing environment. The deployment may execute necessary configurations and commands to implement the cloud software code change. In some implementations, deployment to the cloud computing environment may include automating the deployment of the artifact templates to ensure minimal manual intervention. Additionally, or alternatively, the deployment may include configuration orchestration to distribute changes across multiple cloud instances in a synchronized manner. This orchestration may ensure consistent deployment across different instances.

FIG. 1I depicts a third example configuration of the ISS component of the development system 110. As shown, a development system 110 may employ multiple machine learning models for generating cloud software code and artifacts, performing end-to-end testing, and providing end-to-end assurance. As further shown in FIG. 1I, the development system 110 may include a first set of models (e.g., Model 1, Model 2, Model 3, and Model 4) configured to generate code and artifacts based on a given input. For example, the first set of models may operate in parallel to process the input and produce network-generated code or artifacts. Each model in the set may analyze the input independently, ensuring thorough evaluation and enhancing the reliability of the generated code. The generated output from all models may attain a consensus, resulting in a unified and agreed-upon code and/or artifact. In some implementations, the first set of models may select a most optimal model based on predefined performance metrics to generate the code and artifacts. The performance metrics may include accuracy, speed, or resource efficiency. Additionally, or alternatively, the first set of models may collaborate iteratively, sharing intermediate results to enhance the quality of the generated code or artifacts. By sharing intermediate outcomes, each model may build on the findings of others, resulting in a more refined final product.

As further shown in FIG. 1I, the development system 110 may utilize a second set of models (e.g., Model 5, Model 6, Model 7, and Model 8) for performing end-to-end testing on the generated code and artifacts. These models may form a network to generate a comprehensive set of unit and functional test cases. Each model may contribute unique test scenarios, covering various aspects of the code functionality. The collective test cases may be designed to validate the integrity and effectiveness of the code, ensuring that the code performs as intended. The output of the end-to-end testing may achieve a consensus among all models, consolidating into a combined unique set of test cases ready for execution. In some implementations, the second set of models may generate stress test scenarios to evaluate the performance of the code under different load conditions. Stress tests can help determine how the system behaves under extreme conditions. Additionally, or alternatively, the second set of models may prioritize and filter test cases based on the criticality of software components being tested. Critical components may receive more thorough testing, whereas less critical parts may undergo minimal checks.

As further shown in FIG. 1I, the development system 110 may deploy a third set of models (e.g., Model 9, Model 10, Model 11, and Model 12) for end-to-end assurance. These models may generate assurance profiles, including both open and closed loop use cases, to ensure the robustness and reliability of deployed software changes. Each model in this set may examine different assurance aspects, such as performance metrics, reliability standards, and compliance criteria. The assurance profiles produced by these models may achieve a consensus, combining to form a unique set of test cases executed to secure a final assurance of the software deployment. In some implementations, the third set of models may provide recommendations for remediation actions based on the results of the assurance tests. Remediation steps could include code fixes or configuration changes to address any issues discovered during testing. Additionally, or alternatively, the third set of models may include adaptive learning mechanisms to continuously improve assurance profiles based on feedback from previous deployments. Over time, this adaptive learning capability may increase the accuracy of assurance profiles, making future deployments more reliable. Additionally, or alternatively, the third set of models may assess security vulnerabilities and propose mitigative strategies. Security analysis may ensure that the software is protected against potential threats, with models suggesting patches or configurations to enhance security.

FIG. 1J depicts a fourth example configuration of the ISS component of the development system 110 in relation to the orchestrator system 105. As shown, the development system 110 may include multiple components to securely utilize machine learning models to generate cloud software code changes. The development system 110 may interact with the orchestrator system 105 to achieve end-to-end integration and may include the SIS component and the ISS component.

As shown by reference number 1, the ISS component may include a user interface module, through which orchestrator operations (Orch Ops) may interact with code editors, web applications, and APIs to modify structured and unstructured cloud network function (CNF) MOPs received from a vendor secure file transfer protocol (SFTP). The code editor/chat and web application/API may facilitate editing and communication between the Orch Ops and the ISS component. In some implementations, the SFTP may include using another type of secure protocol, such as a secure copy protocol (SCP) or file transfer protocol (FTP) secure (FTPS). For example, SCP may enhance security through encryption, and FTPS may add additional layers of security.

The ISS component may connect to a vector database and may utilize a model fine-tuning component accessible via large language models (e.g., LLM 1 and LLM 2), as shown by reference number 2. The LLMs and artificial intelligence (AI) models may process the structured and unstructured MOPs, utilizing historical data stored in the vector database to fine-tune models based on real-time feedback. This may enable precise operator specific and site specific customizations. In some implementations, the vector database may include a relational database for managing structured MOPs. For example, a relational database like MySQL can be used for enhanced relational data handling and structured query language (SQL) querying capabilities. Additionally, or alternatively, the LLMs may include alternative AI models like generative pre-trained transformer 3 (GPT-3) or bidirectional encoder representations from transformers (BERT) for fine-tuning based on feedback. For example, GPT-3 may generate human-like text, and BERT can understand the context of words in search queries, thus providing diverse AI model options for fine-tuning.

The ISS component may extend to continuous integration and continuous deployment/testing (CI/CD/CT) platforms for orchestration certification, as shown by reference number 2. The ISS component may certify, orchestrate, and deploy the cloud software code changes into a production (Prod) environment via a test environment, managed through repositories. In some implementations, the CI/CD/CT platforms may include DevOps platforms like Jenkins, GitLab CI, argoCD, or Flux for orchestration and deployment. For example, Jenkins can offer open-source automation while GitLab CI may integrate with GitLab for continuous integration. Additionally, or alternatively, the deployment of changes may include deployment to a staging environment before transitioning the changes to the production environment to ensure stability and performance verification. For example, staging environments may provide for pre-production testing to catch potential issues. Additionally, or alternatively, the CI/CD/CT platforms may include automated security auditing tools integrated into the pipeline to further secure deployments. The certified changes may flow through CI/CD/CT platforms where the App Ops may access Prod and Test environments, manage deployment cycles, and confirm the final implementation in production namespaces using container platforms (CPs), ensuring accurate and efficient cloud software code changes across different deployment sites.

In this way, the development system 110 securely utilizes machine learning models to generate cloud software code changes. For example, the development system 110 may receive cloud CSARs, container images, and data source data for cloud software code within a secure environment and may construct respective repositories and data lakes. The development system 110 may utilize the respective repositories and data lakes to generate a prompt list for updating cloud software code, and may process the prompt list with a machine learning model to produce a generic artifact template. The development system 110 may personalize the generic artifact template with operator specific variables and site specific variables to establish a deployable, site specific artifact template. The development system 110 may provide this template to the orchestrator system 105 for implementing the software changes. Thus, the development system 110 may conserve computing resources, networking resources, and/or other resources that would have otherwise been consumed by requiring significant coding efforts for minor updates or changes to cloud software code, failing to keep up with the latest cloud software code releases from suppliers, failing to provide a streamlined or incremental update approach, failing to efficiently handle hardcoded parameters associated with changes to cloud software code, and/or the like, and/or the like.

As indicated above, FIGS. 1A-1J are provided as an example. Other examples may differ from what is described with regard to FIGS. 1A-1J. The number and arrangement of devices shown in FIGS. 1A-1J are provided as an example. In practice, there may be additional devices, fewer devices, different devices, or differently arranged devices than those shown in FIGS. 1A-1J. Furthermore, two or more devices shown in FIGS. 1A-1J may be implemented within a single device, or a single device shown in FIGS. 1A-1J may be implemented as multiple, distributed devices. Additionally, or alternatively, a set of devices (e.g., one or more devices) shown in FIGS. 1A-1J may perform one or more functions described as being performed by another set of devices shown in FIGS. 1A-1J.

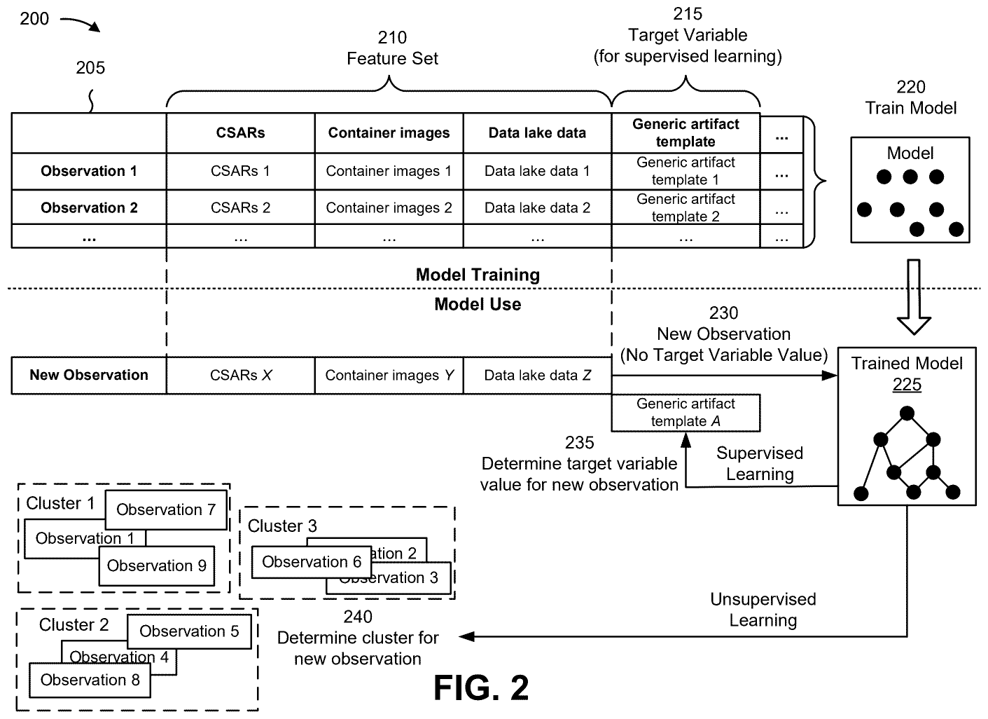

FIG. 2 is a diagram illustrating an example 200 of training and using a machine learning model for generating artifact templates. The machine learning model training and usage described herein may be performed using a machine learning system. The machine learning system may include or may be included in a computing device, a server, a cloud computing environment, and/or the like, such as the development system 110 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the development system 110, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the development system 110. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of CSARs, a second feature of container images, a third feature of data lake data, and so on. As shown, for a first observation, the first feature may have a value of CSARs 1, the second feature may have a value of container images 1, the third feature may have a value of data lake data 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be entitled “generic artifact template” and may include a value of generic artifact template 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of CSARs X, a second feature of container images Y, a third feature of data lake data Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of generic artifact template A for the target variable of the generic artifact template for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a CSARs cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a container images cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to generate artifact templates. The machine learning system enables recognition and/or identification of tens, hundreds, thousands, or millions of features and/or feature values for tens, hundreds, thousands, or millions of observations, thereby increasing accuracy and consistency and reducing delay associated with generating artifact templates relative to requiring computing resources to be allocated for tens, hundreds, or thousands of operators to manually generate artifact templates.

As indicated above, FIG. 2 is provided as an example. Other examples may differ from what is described in connection with FIG. 2.

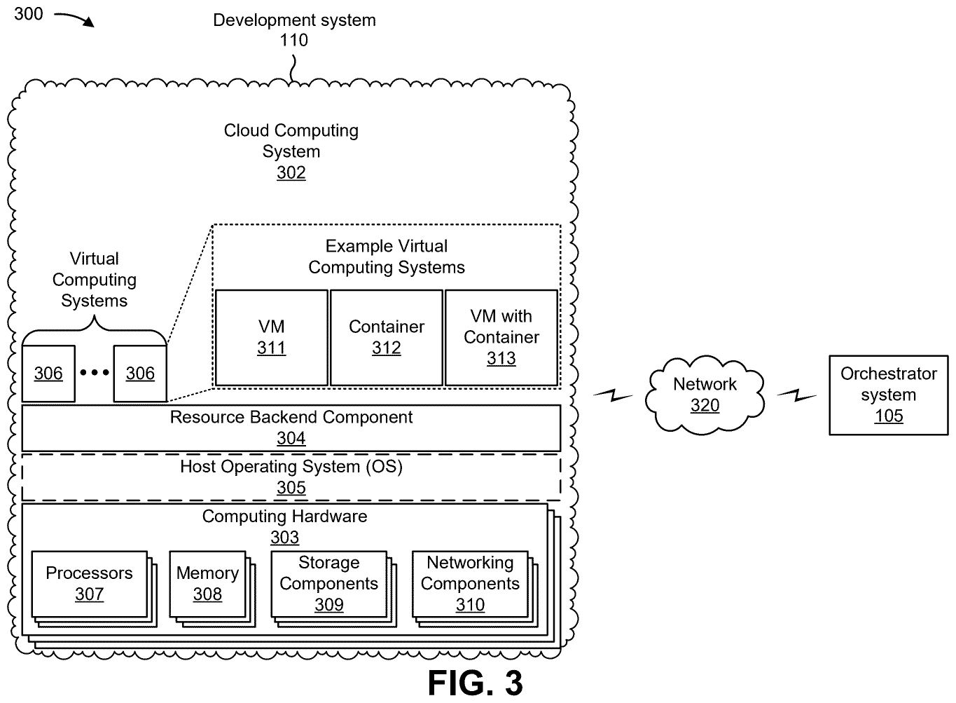

FIG. 3 is a diagram of an example environment 300 in which systems and/or methods described herein may be implemented. As shown in FIG. 3, the environment 300 may include the development system 110, which may include one or more elements of and/or may execute within a cloud computing system 302. The cloud computing system 302 may include one or more elements 303-313, as described in more detail below. As further shown in FIG. 3, the environment 300 may include the orchestrator system 105 and/or a network 320. Devices and/or elements of the environment 300 may interconnect via wired connections and/or wireless connections.

The orchestrator system 105 may include one or more devices capable of receiving, generating, storing, processing, providing, and/or routing information, as described elsewhere herein. The orchestrator system 105 may include a communication device and/or a computing device. For example, the orchestrator system 105 may include a server, such as an application server, a client server, a web server, a database server, a host server, a proxy server, a virtual server (e.g., executing on computing hardware), or a server in a cloud computing system. In some implementations, the orchestrator system 105 may include computing hardware used in a cloud computing environment.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

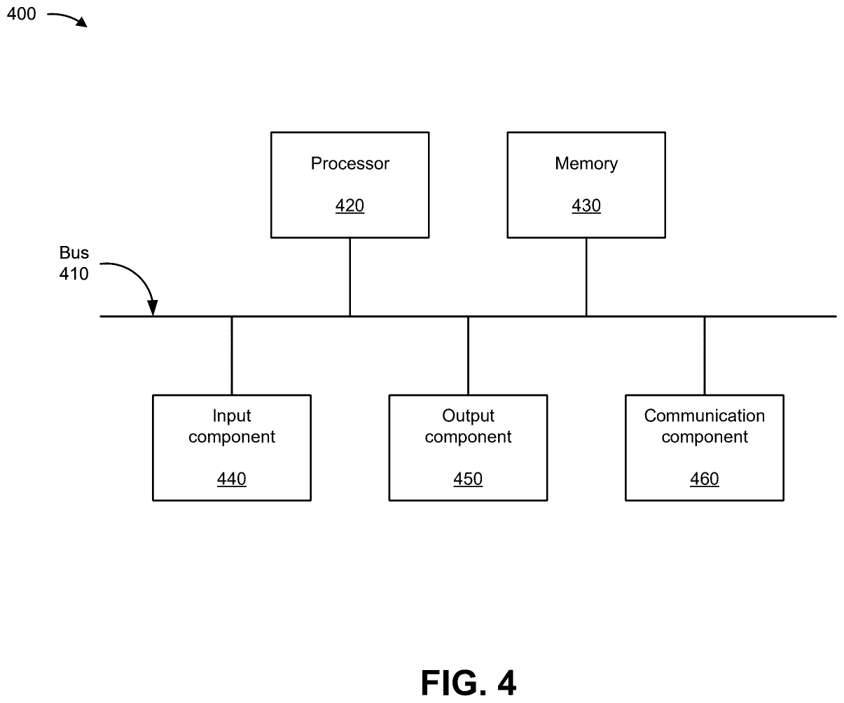

Although the development system 110 may include one or more elements 303-313 of the cloud computing system 302, may execute within the cloud computing system 302, and/or may be hosted within the cloud computing system 302, in some implementations, the development system 110 may not be cloud-based (e.g., may be implemented outside of a cloud computing system) or may be partially cloud-based. For example, the development system 110 may include one or more devices that are not part of the cloud computing system 302, such as the device 400 of FIG. 4, which may include a standalone server or another type of computing device. The development system 110 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the orchestrator system 105 and/or the development system 110. In some implementations, the orchestrator system 105 and/or the development system 110 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

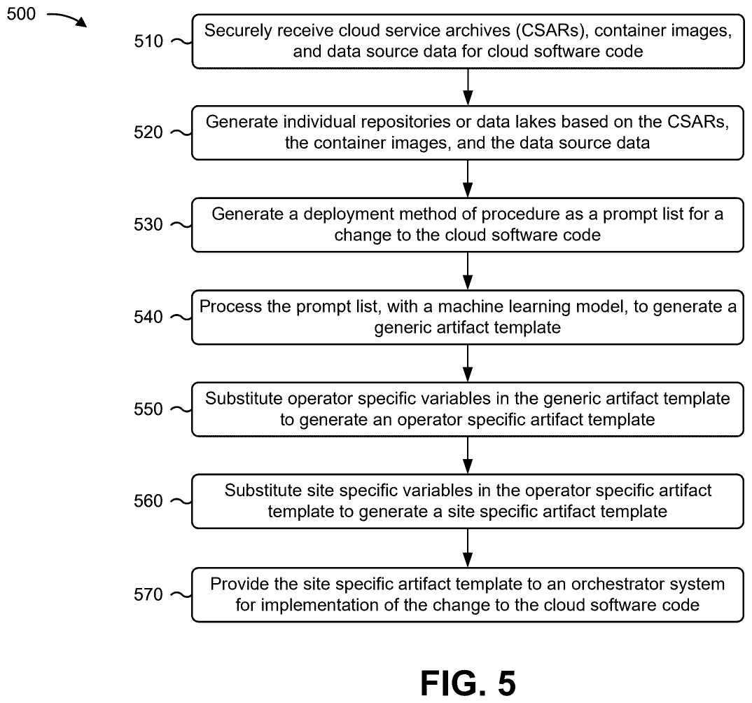

FIG. 5 is a flowchart of an example process 500 for securely utilizing machine learning models to generate cloud software code changes. In some implementations, one or more process blocks of FIG. 5 may be performed by a device (e.g., the development system 110). In some implementations, one or more process blocks of FIG. 5 may be performed by another device or a group of devices separate from or including the device, such as an orchestrator system (e.g., the orchestrator system 105). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include securely receiving CSARs, container images, and data source data for cloud software code (block 510). For example, the device may securely receive CSARs, container images, and data source data for cloud software code, as described above.

As further shown in FIG. 5, process 500 may include generating individual repositories or data lakes based on the CSARs, the container images, and the data source data (block 520). For example, the device may generate repository based on the CSARs, a container image repository based on the container images, and a data lake based on the data source data, as described above.

As further shown in FIG. 5, process 500 may include generating a deployment method of procedure as a prompt list for a change to the cloud software code (block 530). For example, the device may generate a deployment method of procedure as a prompt list for a change to the cloud software code and based on information stored in the repository, the container image repository, and the data lake, as described above.

As further shown in FIG. 5, process 500 may include processing the prompt list, with a machine learning model, to generate a generic artifact template (block 540). For example, the device may process the prompt list, with a machine learning model, to generate a generic artifact template, as described above. In some implementations, the generic artifact template includes scripts for deploying a network function.

As further shown in FIG. 5, process 500 may include substituting operator specific variables in the generic artifact template to generate an operator specific artifact template (block 550). For example, the device may substitute operator specific variables in the generic artifact template to generate an operator specific artifact template, as described above. In some implementations, the operator specific variables include variables associated with paths, versions, environments, and endpoints of the orchestrator system.

As further shown in FIG. 5, process 500 may include substituting site specific variables in the operator specific artifact template to generate a site specific artifact template (block 560). For example, the device may substitute site specific variables in the operator specific artifact template to generate a site specific artifact template, as described above. In some implementations, the site specific variables include variables associated with network addresses, namespaces, and deployment locations.

As further shown in FIG. 5, process 500 may include providing the site specific artifact template to an orchestrator system for implementation of the change to the cloud software code (block 570). For example, the device may provide the site specific artifact template to an orchestrator system for implementation of the change to the cloud software code, as described above. In some implementations, the change to the cloud software code is implemented in a cloud computing environment that includes the cloud software code.

In some implementations, process 500 includes analyzing the information stored in the repository, the container image repository, and the data lake to identify the change to the cloud software code. In some implementations, process 500 includes performing testing on the site specific artifact template prior to providing the site specific artifact template to the orchestrator system. In some implementations, process 500 includes receiving feedback associated with the implementation of the change to the cloud software code, modifying the site specific artifact template based on the feedback and to generate a modified site specific artifact template, and providing the modified site specific artifact template to the orchestrator system for implementation of the change to the cloud software code.

In some implementations, process 500 includes receiving feedback associated with the implementation of the change to the cloud software code, and retraining the machine learning model based on the feedback. In some implementations, process 500 includes analyzing the CSARs, the container images, and the data source data for issues prior to generating the repository, the container image repository, and the data lake. In some implementations, process 500 includes validating the site specific artifact template prior to providing the site specific artifact template to the orchestrator system.

In some implementations, process 500 includes performing end-to-end testing on the site specific artifact template, with a plurality of machine learning models, prior to providing the site specific artifact template to the orchestrator system. In some implementations, process 500 includes generating end-to-end assurance profiles for the site specific artifact template, with a plurality of machine learning models, prior to providing the site specific artifact template to the orchestrator system.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either”or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, securely by a device, cloud service archives (CSARs), container images, and data source data for cloud software code;
generating, by the device, a repository based on the CSARs, a container image repository based on the container images, and a data lake based on the data source data;
generating, by the device, a deployment method of procedure as a prompt list for a change to the cloud software code and based on information stored in the repository, the container image repository, and the data lake;
processing, by the device, the prompt list, with a machine learning model, to generate a generic artifact template;
substituting, by the device, operator specific variables in the generic artifact template to generate an operator specific artifact template;
substituting, by the device, site specific variables in the operator specific artifact template to generate a site specific artifact template; and
providing, by the device, the site specific artifact template to an orchestrator system for implementation of the change to the cloud software code.

2. The method of claim 1, wherein the change to the cloud software code is implemented in a cloud computing environment that includes the cloud software code.

3. The method of claim 1, further comprising:
analyzing the information stored in the repository, the container image repository, and the data lake to identify the change to the cloud software code.

4. The method of claim 1, wherein the operator specific variables include variables associated with paths, versions, environments, and endpoints of the orchestrator system.

5. The method of claim 1, wherein the site specific variables include variables associated with network addresses, namespaces, and deployment locations.

6. The method of claim 1, wherein the generic artifact template includes scripts for deploying a network function.

7. The method of claim 1, further comprising:
performing testing on the site specific artifact template prior to providing the site specific artifact template to the orchestrator system.

8. A device, comprising:
one or more processors configured to:
receive, securely by a device, cloud service archives (CSARs), container images, and data source data for cloud software code;
generate a repository based on the CSARs, a container image repository based on the container images, and a data lake based on the data source data;
generate a deployment method of procedure as a prompt list for a change to the cloud software code and based on information stored in the repository, the container image repository, and the data lake;
process the prompt list, with a machine learning model, to generate a generic artifact template;
substitute operator specific variables in the generic artifact template to generate an operator specific artifact template;
substitute site specific variables in the operator specific artifact template to generate a site specific artifact template; and
provide the site specific artifact template to an orchestrator system for implementation of the change to the cloud software code,
wherein the change to the cloud software code is implemented in a cloud
computing environment that includes the cloud software code.

9. The device of claim 8, wherein the one or more processors are further configured to:
receive feedback associated with the implementation of the change to the cloud software code;
modify the site specific artifact template based on the feedback and to generate a modified site specific artifact template; and
provide the modified site specific artifact template to the orchestrator system for implementation of the change to the cloud software code.

10. The device of claim 8, wherein the one or more processors are further configured to:
receive feedback associated with the implementation of the change to the cloud software code; and
retrain the machine learning model based on the feedback.

11. The device of claim 8, wherein the one or more processors are further configured to:
analyze the CSARs, the container images, and the data source data for issues prior to generating the repository, the container image repository, and the data lake.

12. The device of claim 8, wherein the one or more processors are further configured to:
validate the site specific artifact template prior to providing the site specific artifact template to the orchestrator system.

13. The device of claim 8, wherein the one or more processors are further configured to:
perform end-to-end testing on the site specific artifact template, with a plurality of machine learning models, prior to providing the site specific artifact template to the orchestrator system.

14. The device of claim 8, wherein the one or more processors are further configured to:
generate end-to-end assurance profiles for the site specific artifact template, with a plurality of machine learning models, prior to providing the site specific artifact template to the orchestrator system.

15. A non-transitory computer-readable medium storing a set of instructions, the set of instructions comprising:
one or more instructions that, when executed by one or more processors of a device, cause the device to:
receive, securely by a device, cloud service archives (CSARs), container images, and data source data for cloud software code;
generate a repository based on the CSARs, a container image repository based on the container images, and a data lake based on the data source data;
generate a deployment method of procedure as a prompt list for a change to the cloud software code and based on information stored in the repository, the container image repository, and the data lake;
process the prompt list, with a machine learning model, to generate a generic artifact template;
substitute operator specific variables in the generic artifact template to generate an operator specific artifact template;
substitute site specific variables in the operator specific artifact template to generate a site specific artifact template,
wherein the site specific variables include variables associated with network addresses, namespaces, and deployment locations; and
provide the site specific artifact template to an orchestrator system for implementation of
the change to the cloud software code.

16. The non-transitory computer-readable medium of claim 15, wherein the one or more instructions further cause the device to:
analyze the information stored in the repository, the container image repository, and the data lake to identify the change to the cloud software code.

17. The non-transitory computer-readable medium of claim 15, wherein the one or more instructions further cause the device to:
perform testing on the site specific artifact template prior to providing the site specific artifact template to the orchestrator system.

18. The non-transitory computer-readable medium of claim 15, wherein the one or more instructions further cause the device to:
receive feedback associated with the implementation of the change to the cloud software code;
modify the site specific artifact template based on the feedback and to generate a modified site specific artifact template; and
provide the modified site specific artifact template to the orchestrator system for implementation of the change to the cloud software code.

19. The non-transitory computer-readable medium of claim 15, wherein the one or more instructions further cause the device to:
receive feedback associated with the implementation of the change to the cloud software code; and
retrain the machine learning model based on the feedback.

20. The non-transitory computer-readable medium of claim 15, wherein the one or more instructions further cause the device to:
perform end-to-end testing on the site specific artifact template, with a plurality of machine learning models, prior to providing the site specific artifact template to the orchestrator system; and
generate end-to-end assurance profiles for the site specific artifact template, with another plurality of machine learning models, prior to providing the site specific artifact template to the orchestrator system.
